(19) United States
(12) Patent Application Publication
(10) Pub. No.: US 2025/0241392 A1
(43) Pub. Date: Jul. 31, 2025

(54) Method for Making Customized Articles of Clothing and Articles of Clothing Producted by the Same

(71) Applicant: Yasmina Khan, Los Angeles, CA (US)

(72) Inventor: Yasmina Khan, Los Angeles, CA (US)

(73) Assignee: Uniphorm Corp., Los Angeles, CA (US)

(21) Appl. No.: 18/848,490

(22) PCT Filed: Mar. 31, 2023
(86) PCT No.: PCT/US2023/065211

§ 371 Date: Sep. 18, 2024

Related U.S. Application Data
(60) Provisional application No. 63/327,764, filed on Apr. 5, 2022.

(51) Int. Cl. A41H 3/00; A41D 27/00; B33Y 50/00; B33Y 80/00

(52) U.S. Cl. CPC A41H 3/00; A41D 27/00; B33Y 50/00; B33Y 80/00

(57) ABSTRACT

Disclosed herein are methods of producing a customized article of clothing configured to reposition the soft tissue of the wearer to their specifications and desire, the method comprising: creating a 3-dimensional avatar of a body; manipulating the style and desired levels of coverage, lift, and compression of the body via digital input; and producing the garment by additive manufacturing. Also disclosed are articles of clothing produced by the method.

### FIELD OF THE INVENTION

The disclosure relates to methods for producing customized articles of clothing, in particular, methods for producing articles of clothing customized with respect to style, coverage, lift, and/or compression as designated by a user; and to articles of clothing produced by said methods.

### BACKGROUND

Many people wear articles of clothing that require a particular fit on the body. For example, garments such as brassieres, girdles, underwear, and the like are often sized and shaped to provide a certain level of coverage, lift, and/or compression. However, many such garments are uncomfortable to wear because of standard sizing within the garment industry. Such standard sizing typically assumes that the person wearing the garment has a higher degree of lateral symmetry than many people experience.

Moreover, the cost of producing and stocking many different sizes of any particular garment can be extremely high. It is difficult to predict the precise number of each size needed. Underestimating the quantity of a certain size and style can result in consumers wearing the incorrect garment, which could lead to the consumer discarding the ill-fitting garments before their life-cycles are up. On the other hand, overestimating the quantity of a certain size leads to wasted resources, including materials, labor, storage space, and disposal. By some estimations more than 84% of clothing ends up in landfill or incinerators.

Consumers increasingly desire the ability to provide input as to the fit and style of clothing and undergarments.

Some have proposed producing customized garments from an image, series of images, or 3-dimensional scan. However, these methods produce a model of the body that is generally static. That is, the garment is typically designed to fit around a static and solid surface.

It has now been surprisingly and unexpectedly discovered that a method including creating a 3-dimensional avatar of a body; manipulating the style and desired levels of coverage, lift, and compression of the body via digital input; and producing the garment by additive manufacturing, can provide a garment with a highly customized level of style and fit. Such methods may be useful in applications wherein benefits such as repositioning of soft tissue to create a desired silhouette, fit, and/or other effect.

### SUMMARY

The disclosure relates, in various embodiments, to a method of producing a customized article of clothing configured to reposition the soft tissue of the wearer to their specifications and desire, the method comprising:
creating a 3-dimensional avatar of a body;
manipulating the style and desired levels of coverage, lift, and compression of the body via digital input;
and producing the garment by additive manufacturing.

In some embodiments, the 3-dimensional avatar is created from an image, a series of images, a video, and/or a 3-dimensional scan.

In further embodiments, the body is conformed into a desired position prior to creating a 3-dimensional avatar of the body.

According to certain embodiments, the digital input used to manipulate the style and fit are analyzed by an algorithm before the garment design is finalized and produced.

Other embodiments of the disclosure include an article of clothing prepared by a method comprising:
creating a 3-dimensional avatar of a body;
manipulating the style and desired levels of coverage, lift, and compression of the body via digital input;

and producing the garment by additive manufacturing, wherein the article of clothing is configured to reposition the soft tissue of the wearer to their specifications and desire.

Additional features and advantages of the disclosed embodiments as claimed will be set forth in the detailed description which follows, and in part will be readily apparent to those skilled in the art from that description or recognized by practicing the invention as claimed herein, including the detailed description which follows, as well as the claims.

It is to be understood that both the foregoing general description and the following detailed description present various embodiments of the disclosure, and are intended to provide an overview or framework for understanding the nature and character of the claims.

### BRIEF DESCRIPTION OF THE DRAWINGS

The accompanying drawings, which are included to provide a further understanding of the invention and are incorporated in and constitute a part of this specification, together with the description serve to explain the principles of the invention.

FIG. 1A is a flowchart illustrating a process for producing a customized article of clothing according to an embodiment of the invention.

FIG. 1B is a flowchart illustrating a process for producing a customized article of clothing according to another embodiment of the invention.

FIG. 1C is a flowchart illustrating a process for producing a customized article of clothing according to an embodiment of the invention.

FIG. 1D is a flowchart illustrating a process for producing a customized article of clothing according to an embodiment of the invention.

FIGS. 2A-K are a series of images showing a digital interface that allows an end user to customize a bra according to embodiments of the invention.

### DETAILED DESCRIPTION

In various embodiments, the disclosure relates to methods for producing customized articles of clothing, in particular, methods for producing articles of clothing customized with respect to style, coverage, lift, and/or compression as designated by a user; and to articles of clothing produced by said methods.

The method according to embodiments of the disclosure may be used to produce, for example, garments for covering, lifting, and/or compressing parts of the body, for example soft tissue of the body such as breast tissue, genital tissue, body fat, or skin. In particular, the garment, undergarment, or foundational garment may be selected from, for example, a brassiere, vest, arm sleeve, wrist covering, glove, finger covering, underwear, long underwear, groin guard or athletic supporter, leg sleeve, knee covering, ankle covering, sock, toe covering, hat, or head covering.

As used herein, the term “end user” is defined as the person who will wear the customized garment according to embodiments of the invention. The term “end user” may also refer herein to the person who performs one or more of the steps according to the disclosed method. It is understood that a person other than the end user may perform one or more of the steps to produce the final garment. A person other than the end user may perform the steps to produce the final garment as a gift for the end user or to aid the end user in the necessary steps to produce the final garment.

### Digital Avatar

The methods according to the disclosed embodiments comprise producing at least one digital avatar of the body or body part on which the garment is to be worn. Digital avatars can also be referred to interchangeably herein as a three-dimensional (“3D”) computational or graphical representation of a body or body part.

The digital avatar may be created from an image or series of images, a video, or a 3D scan of the relevant area of the body. In certain embodiments, the images, video, or 3D scan may be obtained from any number of widely-available devices, for example a smart phone, digital camera, video camera, webcam, or traditional images or videos that are subsequently digitized. In other embodiments, a 3D scan may be chosen from millimeter wave imaging scanners, projected light scanners, structured light scanners, modulated light scanners, laser scanners, laser triangulation scanners, laser time-of-flight scanners, optically tracked 3D scanners, stereoscopic video or photographic systems, photometric systems, photogrammetric techniques, or silhouette techniques.

Software is used to convert the images, video, or 3D scan into a point cloud, series of lines or a software generated surface.

According to various embodiments, the digital avatar represents the body or a body part of the end user of the garment produced by the method of the invention. In other embodiments, the digital avatar represents at least one prosthetic that is intended to be worn with the garment by the end user.

### Customization of Designated Parameters

In certain embodiments, the garment may be customized by designating at least one parameter, for example style, coverage, lift, and/or compression.

In some embodiments, the garment is a bra. A proper fit can result in a more comfortable wearing experience along with the desired style and performance characteristics such as shape and support. Important elements when considering a proper fit for a bra include coverage, lift, and/or compression.

According to embodiments of the invention, a parameter may be customized from input from the end user. In some embodiments, the end user may select a value for a parameter by, for example entering a value, entering a percentage, or using a sliding scale to select from a range of values.

In other embodiments, the end user inputs a desired characteristic of the garment, and an assistant converts the desired characteristic into at least one parameter value. The assistant can be chosen from a person, a virtual assistant, or an algorithm.

### Additive Manufacturing

The garment according to the disclosed embodiments can be produced by additive manufacturing techniques. Some examples of additive manufacturing techniques include fused deposition modeling, fused filament fabrication, stereolithography, digital light processing, masked stereolithography, programmable photopolymerization, high area rapid printing, lithography-based metal manufacturing, light enabled additive production, projection micro stereolithography, digital composite manufacturing, selective laser sintering, selective laser melting, electron beam melting, multi jet fusion, material jetting, drop on demand, nanoparticle jetting, color jet printing, binder jetting, laminated object manufacturing, laser engineered net shaping, electron beam additive manufacturing, directed light fabrication, rapid plasma deposition and wire arc additive manufacturing.

In some embodiments, the garment is produced by 3d printing.

Arranging Body into Desired Position

The method according to the disclosed embodiments optionally comprises arranging at least one body part into a desired position prior to taking the images used to create the digital avatar. This allows the body to assume a different silhouette, for example to compress, minimize, enhance, and/or lift certain areas of the body.

As used herein, a “soft tissue” is meant to include a body part that is capable, by itself or in the presence of external manipulation, of being repositioned with respect to other body parts. In some embodiments, the body part is a soft tissue, for example breast tissue, body fat, skin, external genitals, or other repositionable body parts.

The term “soft tissue” as used herein is also meant to include one or more prosthetics or other objects that may be worn in conjunction with the garment. Nonlimiting examples of such prosthetics include external breast protheses, external penile prostheses, external testicular prostheses, external muscle prostheses, external breast enhancers, external penile enhancers, external testicular enhancers, and external muscle enhancers.

In some embodiments, the at least one body part is arranged with the use of external manipulation such as tape, ribbon, film, sheet material, adhesive sheets, compression garments, brassieres, shapewear, stockings, and silicone prosthetics.

Other embodiments use gravity to assist the arrangement of body parts. For example, the subject may be imaged while seated; laying down in a prone, supine, or lateral position; bending over forward or backward; suspended or hanging upside down or in any other position; or otherwise positioned to allow gravity to assist in arranging certain body parts.

### Additional Steps

The methods according to some embodiments of the disclosure may further comprise additional steps that are typically used in garment manufacturing. Such components are known to those of skill in the art, or are within the ability of those of skill in the art to determine depending on the particular application, such as, for example, closures, fit adjusters, embellishments for style and/or comfort, and combinations thereof.

In some embodiments, the garment includes features that allow for varied fit, coverage, and/or style. For example, the garment may include adjustable closures such as multiple rows of hooks or other fasteners. The garment may include removable panels for different styles, colors, and/or levels of coverage. According to certain embodiments, the garment may include integrated or removable logos or branding styles or other stylistic elements.

### Garment

In certain exemplary embodiments, the garments produced by the disclosed methods are in the form of undergarments such as brassieres, compression vests, enhancement underwear, or compression underwear. In various embodiments, the garment may be athletic or everyday wear such as a shirt, pants, shorts, arm or leg sleeves, hat or other headwear, gloves, footwear, sport bra, or athletic support cup.

According to some embodiments, the garment is a bra for supporting and/or compressing breast tissue. Because breast tissue includes soft tissue that can be rearranged, the garment is designed to provide a custom amount of reshaping of the soft tissue. In some cases, the soft tissue is supported and lifted. In other cases, the breast tissue is compressed. A garment that compresses breast tissue is sometimes referred to as a compression vest.

In other embodiments, the garment is underwear intended to be worn around the pelvic area of a body. In some cases, the garment is designed to support, lift, or otherwise enhance the soft tissue in this area. In other cases, the garment is designed to compress or otherwise minimize the soft tissue in the pelvic area.

In some embodiments, the garment changes the appearance of certain areas of the body of the end user, for example the neck, the shoulder area, the bust area, the waist area, the buttock area, the hip area, the arm area, and/or the leg area. The change in appearance can be a change in the general shape of an area, for example elongated, extended, compressed, rounded, squared, or rectangular. Nonlimiting examples include creating an extended or elongated neck area, a compressed neck area, an extended or enlarged rounded shoulder area, a square or rectangular shoulder area, an extended or enlarged rounded bust line, an extended or enlarged square or rectangular bust line, a compressed waist line, an extended or enlarged waist line, a compressed hip line, an extended or enlarged rounded hip line, an extended or enlarged square or rectangular hip line, a compressed buttock area, an extended or enlarged rounded buttock area, or an extended or enlarged square or rectangular buttock area.

### Method

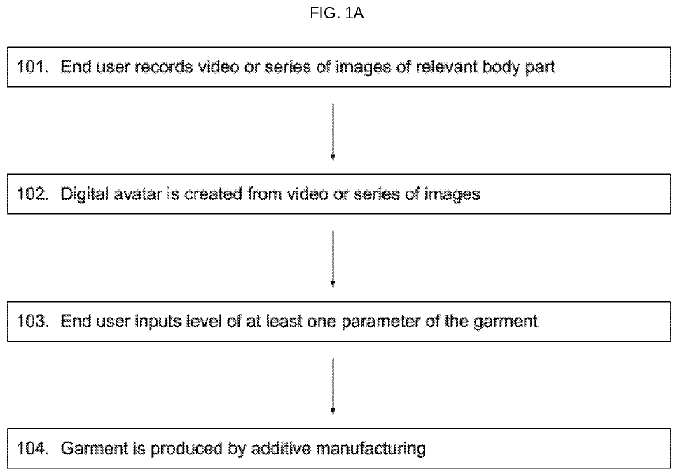

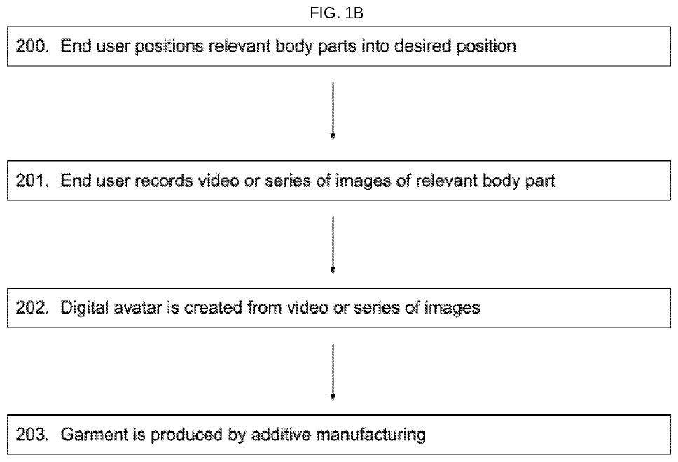

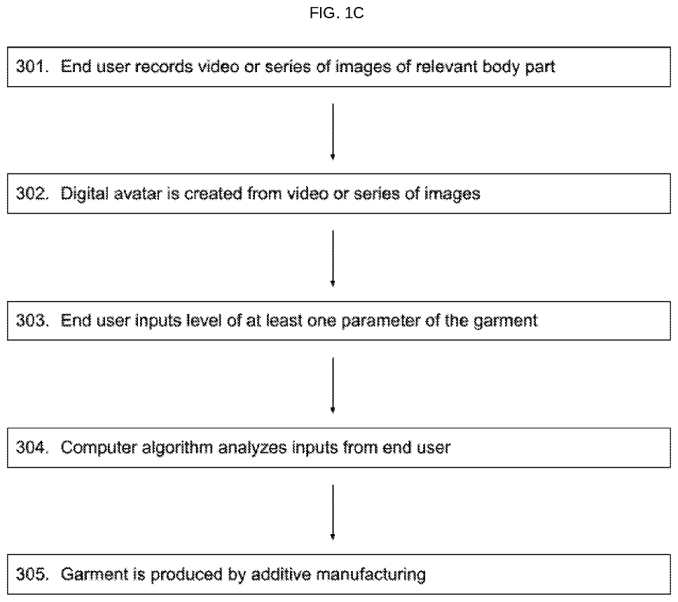

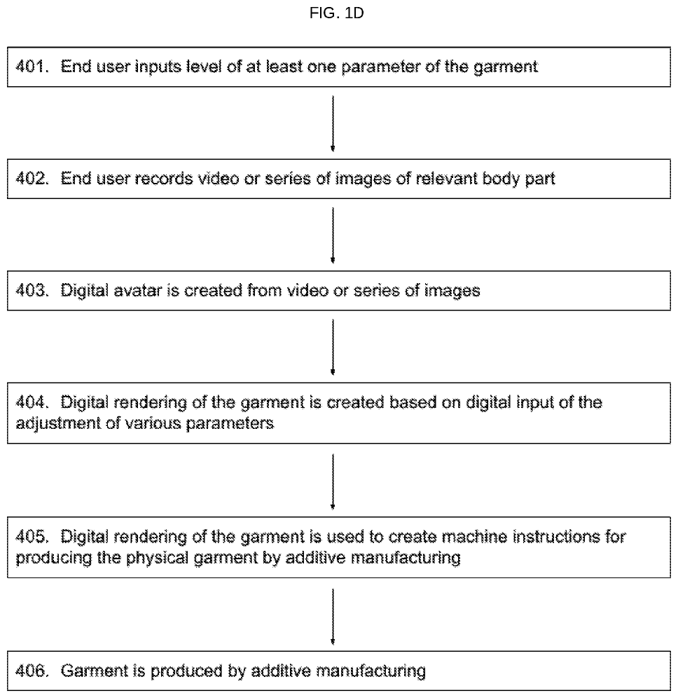

FIGS. 1A-1C are flowcharts of various methods according to embodiments of the invention.

As shown in step 101 of FIG. 1A, the end user then records a video or series of images of their body, or the target body part. The video or images may be digital. If the video or images are not digital, the video or images are digitized.

In step 102, a digital avatar is created from the digital video or images. An initial digital rendering of the garment is created based on the digital avatar.

Step 103 allows the end user to adjust at least one parameter of the garment, for example by setting the desired levels of coverage, lift, and compression. The initial digital rendering of the garment is then altered based on digital input of the adjustment of various parameters.

In step 104, the customized digital rendering of the garment is used to create machine instructions for producing the physical garment by additive manufacturing, and the garment is produced by additive manufacturing, for example 3D printing.

FIG. 1B shows an optional step 200, wherein the end user conforms certain parts of their body into the desired position. In step 201, the end user then records a video or series of images of their body, or the target body part. The video or images may be digital. If the video or images are not digital, the video or images are digitized. In step 202, a digital avatar is created from the digital video or images. An initial digital rendering of the garment is created based on the digital avatar. In some embodiments, the end user can adjust at least one parameter of the garment, for example by setting the desired levels of coverage, lift, and/or compression. In other embodiments, the end user does not set the desired levels of coverage, lift, and/or compression. In step 203, the customized digital rendering of the garment is used to create machine instructions for producing the physical garment by additive manufacturing, and the garment is produced by additive manufacturing, for example 3D printing.

Steps 301, 302, and 303 of FIG. 1C are analogous to steps 101, 102, and 103 as described in FIG. 1A. The embodiment according to FIG. 1C shows step 304, wherein a computer algorithm analyzes the end user inputs to determine the feasibility of the desired effects. In step 305, the customized digital rendering of the garment is used to create machine instructions for producing the physical garment by additive manufacturing, and the garment is produced by additive manufacturing, for example 3D printing.

The embodiment described in FIG. 1D includes step 401, wherein an end user inputs a level of at least one parameter of the garment. In step 402, the end user records a video or series of images of a relevant body part, and a digital avatar is created from the video or series of images in step 403. In step 404, a digital rendering of the garment to fit the digital avatar is created based on digital input of the adjustment of various parameters. In step 405, the digital rendering of the garment is used to create machine instructions for producing a physical garment by additive manufacturing. The garment is produced by additive manufacturing in step 406.

Modifications, additions, or omissions may be made to the methods described herein without departing from the scope of the disclosure. The methods described may include more, fewer, or other steps. Additionally, steps may be performed in any suitable order.

In some embodiments, the end user adjusts at least one parameter of the garments before creating a digital avatar from a video or series of images.

It is to be understood that, as used herein the terms “the,” “a,” or “an,” mean “at least one,” and should not be limited to “only one” unless explicitly indicated to the contrary. Thus, for example, reference to “a portion” includes examples having two or more such portions unless the context clearly indicates otherwise.

It should be understood that all patents and published patent applications referenced are incorporated herein in their entireties.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C. As described, the phrase “at least one of A, B, and C” is intended to include “at least one A or at least one B or at least one C,” and is also intended to include “at least one A and at least one B and at least one C.”

All ranges and amounts given herein are intended to include subranges and amounts using any disclosed point as an end point. Thus, a range of “1% to 10%, such as 2% to 8%, such as 3% to 5%,” is intended to encompass ranges of “1% to 8%,” “1% to 5%,” “2% to 10%,” and so on.

All numbers, amounts, ranges, etc., are intended to be modified by the term “about,” whether or not so expressly stated. Similarly, a range given of “about 1% to 10%” is intended to have the term “about” modifying both the 1% and the 10% endpoints.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure. For example, the term “about” can mean within 10% of the indicated number (e.g. “about 10%” means 9%-11% and “about 2%” means 1.8%-2.2%), such as within 9%, 8%, 7%, 6%, 5%, 4%, 3%, 2%, or 1%, according to various embodiments.

Notwithstanding that the numerical ranges and parameters setting forth the broad scope of the disclosure are approximations, unless otherwise indicated the numerical values set forth in the specific examples are reported as precisely as possible. Any numerical value, however, inherently contains certain errors necessarily resulting from the standard deviation found in their respective testing measurements. The example that follows serves to illustrate embodiments of the present disclosure without, however, being limiting in nature.

It is understood that when an amount of a component is given, it is intended to signify the amount of the active material, unless otherwise indicated.

The methods and garment according to the present disclosure can comprise, consist of, or consist essentially of the elements and limitations described herein, as well as any additional or optional ingredients, components, or limitations described herein or otherwise known in the art.

It will be apparent to those skilled in the art that various modifications and variations can be made in the delivery system, methods and garments of the invention without departing from the spirit or scope of the invention. Thus, it is intended that the present invention cover the modifications and variations of this invention provided that they come within the scope of the appended claims and their equivalents.

### EXAMPLES

The following Examples are provided for illustrative purposes only, and are not intended to be limiting.

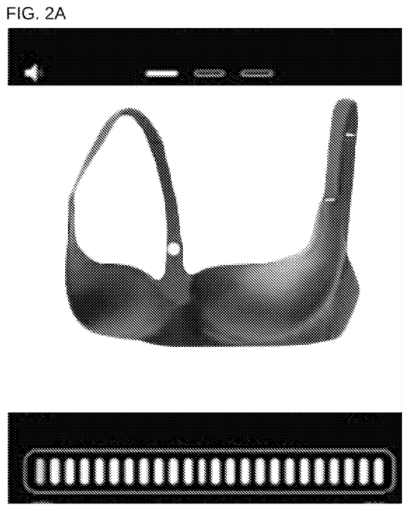

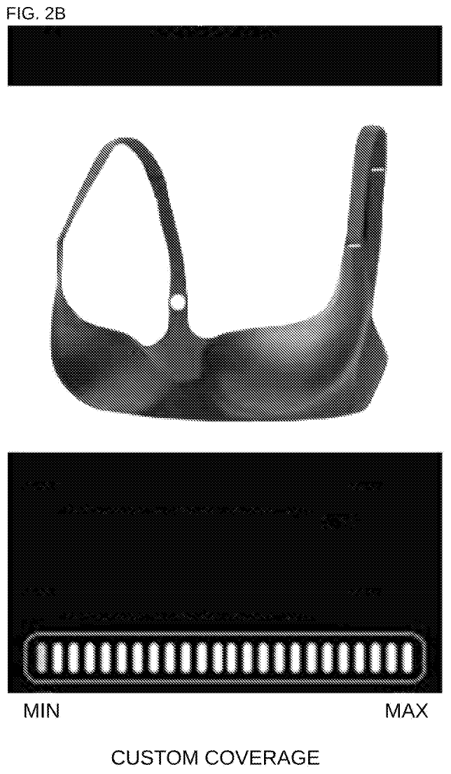

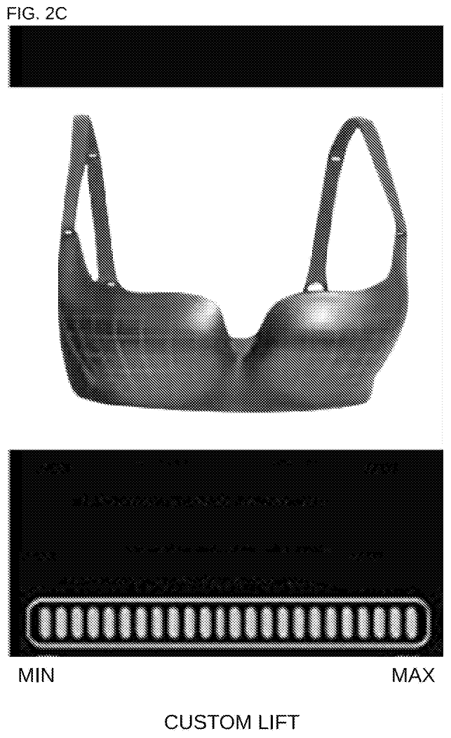

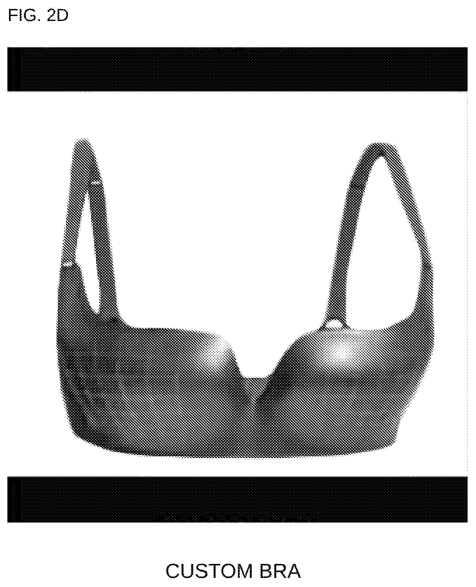

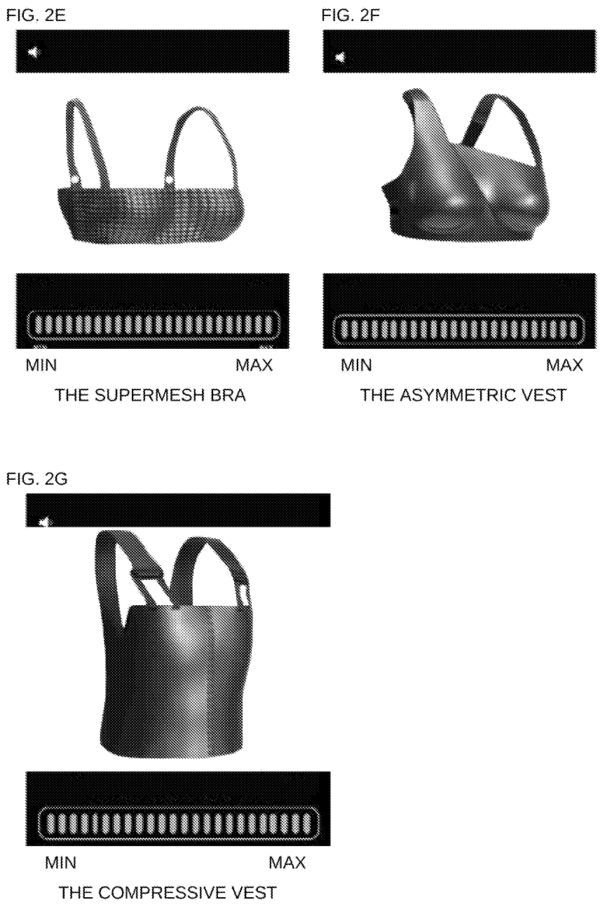

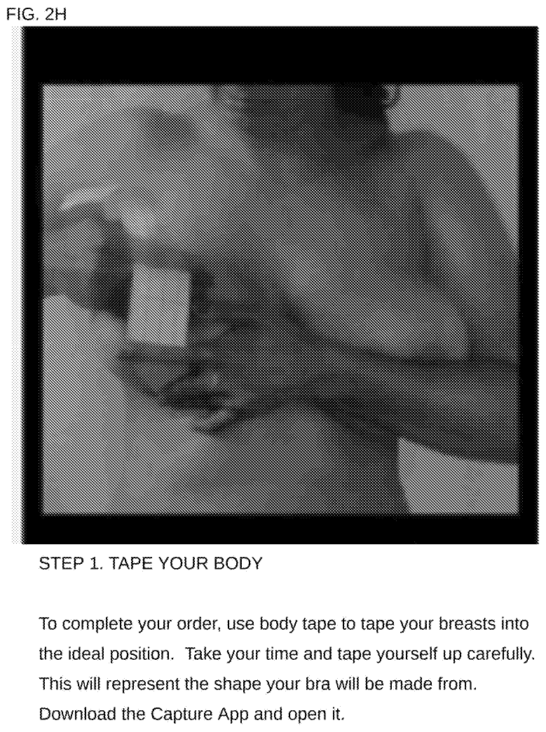

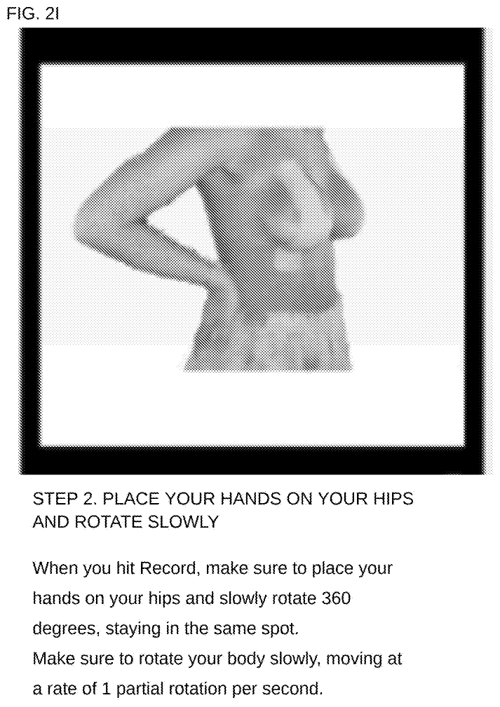

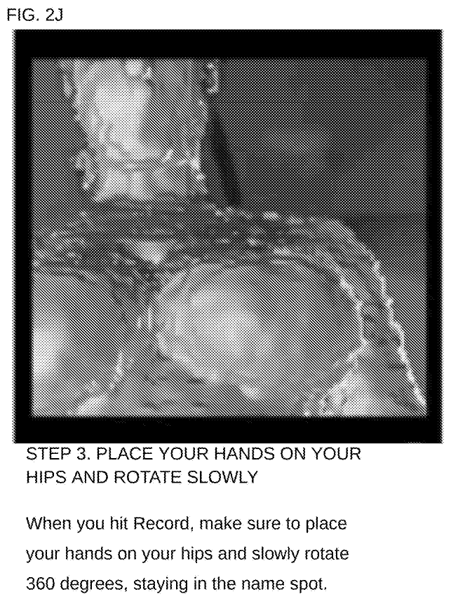

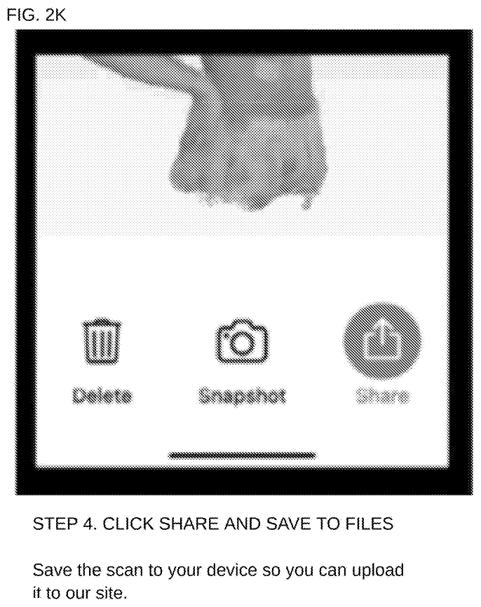

FIGS. 2A-K are renderings of a digital interface that allows an end user to customize a bra. The digital interface may be an Internet website, part of an intranet, or a stand-alone screen or kiosk.

FIG. 2A shows the first page of the digital interface, with an animation of a bra highlighting the product details and customization features.

FIG. 2B shows a page that allows for customization of coverage. A slider bar allows the end user to choose the amount of coverage, and the animation of the bra is adjusted accordingly to reflect the input by the end user.

FIG. 2C shows a page that allows for customization of lift. A slider bar allows the end user to choose the amount of lift, and the animation of the bra is adjusted accordingly to reflect the input by the end user.

FIG. 2D shows a digital rendering of the bra as customized by the end user.

FIGS. 2E and 2F show two other bra styles, while FIG. 2G shows a compression vest.

FIGS. 2H-2K are pages showing how to take and upload a 3D scan of the end user's body using an application on a smartphone, tablet, or computer. FIG. 2H demonstrates how to use tape to support breast tissue to the desired position prior to taking the 3D scan. FIG. 21 shows the preferred stance for taking a 3D scan of the torso including breast tissue. FIG. 2J shows a digital rendering of the body as taken by the 3D scan. FIG. 2K is a page showing how to upload the 3D scan in order to create a digital avatar.

After the end user has submitted the levels of customization and 3D scan, a digital rendering of the bra is created by software. Machine instructions for a 3D printer are then created from the digital rendering of the bra, and the bra is produced with a 3D printer.

1. A method of producing a customized article of clothing configured to reposition the soft tissue of a wearer's body, the method comprising:
creating a 3-dimensional avatar of the wearer's body;
manipulating the style and desired fit, including levels of coverage, lift, and compression of the body, via digital input; and
producing a customized article of clothing by additive manufacturing based on the 3-dimensional avatar and the manipulation of the style and fit.

2. The method of claim 1, wherein the 3-dimensional avatar is created from one or more chosen from an image, a series of images, a video, a 3-dimensional scan, and combinations thereof.

3. The method of claim 1, further comprising conforming the body into a desired position before creating a 3-dimensional avatar of the body by repositioning the soft tissue of the wearer's body.

4. The method of claim 1, further comprising analyzing via an algorithm wherein the digital input used to manipulate the style and fit before producing the customized article of clothing.

5. An article of clothing prepared by a method comprising:
creating a 3-dimensional avatar of the body of a wearer;
manipulating the style and fit, including desired levels of coverage, lift, and compression of the body, via digital input; and
producing a customized article of clothing by additive manufacturing based on the 3-dimensional avatar and the manipulation of the style and fit,
wherein the article of clothing is configured to reposition the soft tissue of the wearer's body to-their-specifications and desire.

6. The method of claim 3, wherein the soft tissue of the wearer's body is repositioned using one or more chosen from tape, ribbon, film, sheet material, adhesive sheet, compression garment, brassiere, shapewear, stocking, and silicone prosthetic.

7. A method of producing a customized article of clothing configured to reposition the soft tissue of a wearer's body, the method comprising:
conforming a wearer's body into a desired position by repositioning the soft tissue of the wearer's body; and then
creating a 3-dimensional avatar of the wearer's body;
manipulating the style and desired fit, including levels of coverage, lift, and compression of the body, via digital input; and
producing a customized article of clothing based on the 3-dimensional avatar and the manipulation of the style and fit.

8. The method of claim 7, wherein the soft tissue of the wearer's body is repositioned using one or more chosen from tape, ribbon, film, sheet material, adhesive sheet, compression garment, brassiere, shapewear, stocking, and silicone prosthetic.

9. The method of claim 7, wherein the 3-dimensional avatar is created from one or more chosen from an image, a series of images, a video, a 3-dimensional scan, and combinations thereof.

10. The method of claim 7, wherein the customized article of clothing is produced by additive manufacturing.

11. The method of claim 7, further comprising analyzing via an algorithm wherein the digital input used to manipulate the style and fit before producing the customized article of clothing.
